(19) United States
(12) Patent Application Publication
(10) Pub. No.: US 2008/0008886 A1
(43) Pub. Date: Jan. 10, 2008

(54) METHOD OF MANUFACTURING A FOAMED VEHICLE PART, AND FOAMED VEHICLE PART

(76) Inventors: Matthias Ludwig, Vechelde (DE); Tobias Niesner, Gifhorn (DE)

Correspondence Address: CARLSON, GASKEY & OLDS, P.C., 400 WEST MAPLE ROAD, SUITE 350, BIRMINGHAM, MI, 48009, US

(21) Appl. No.: 11/773,449

(22) Filed: Jul. 5, 2007

(30) Foreign Application Priority Data
Jul. 6, 2006 (EP) 06 014 016.7

(51) Int. Cl. B05D 5/00

(52) U.S. Cl. 428/411.1; 427/401; 427/421.1

(57) ABSTRACT

A method of manufacturing a foamed vehicle part includes reshaping a transparent sheet that serves as an outer skin, and which has a front side and a rear side. A wet paint is applied onto the rear side of the transparent sheet to form a coloring layer. The transparent sheet is then provided with a foamed backing on the rear side.

### RELATED APPLICATIONS

The application claims priority to European Application No. 06 014 016.7, which was filed on 6 Jul. 2006.

### BACKGROUND OF THE INVENTION

The present invention relates to a method of manufacturing a foamed vehicle part and further to a foamed vehicle part.

Foamed vehicle parts include vehicle body panel parts such as flaps (doors, covers), bumpers or roof modules, among other parts. These parts are fitted to a vehicle body, define at least sections of an outer skin of the vehicle in the final assembled condition, and are visible from outside. In addition, there are foamed vehicle parts including a glass-fiber reinforced polyurethane (PU) material, the glass fibers being, for instance, injected into a plastic material in a long fiber injection (LFI) method. In this method, a deep-drawn, solid-colored sheet made of a plastic material or aluminum is placed into a foaming mold and is provided with a foamed backing. The solid-colored sheet is dyed throughout its depth and its extension to replace an external paintwork.

One important aspect in the manufacture of a foamed vehicle part is that the color of the vehicle part should not differ from the color of the adjacent, painted body, so that a continuous colored surface is produced. However, when the solid-colored sheet known from the prior art is reshaped, shades or tints may appear at corners and edges interrupting the even colored surface. This discoloration particularly occurs when metallic colors are used.

It is the object of the present invention to provide a foamed vehicle part that exhibits a uniform color over its entire outer surface. It is another object of the present invention to provide a method of manufacturing such a foamed vehicle part, which likewise features a uniform outer color, simply and at reasonable cost.

### SUMMARY OF THE INVENTION

This is achieved by a method according to the invention for manufacturing a foamed vehicle part that includes the following steps that are carried out in sequence. A transparent sheet serving as an outer skin and having a front side and a rear side is reshaped. The rear side of the sheet receives a wet application of a paint to form a coloring layer. The sheet is provided with a foamed backing on the rear side.

The outer skin is a colorless transparent sheet that is reshaped. Reshaping means that the outer skin is exposed to external forces and, optionally, to heat in order to obtain a permanent and new outer geometry and shape without cutting operations. After reshaping, a wet paint is applied immediately on the rear side of the sheet, i.e. the coloring layer is not a sheet that is glued on or the like but, rather, the paint first needs to dry after the application. The paint that is applied forms a coloring layer for the outer face of the vehicle part, which is no longer painted on the outside. The sheet is subsequently provided with a foamed backing on the rear side, i.e. the side which is not visible from outside in an installed condition. In one example, the foaming liquid plastic material is applied immediately onto the coloring layer and is hardened, or is self-hardening on it, to be attached to the coloring layer. Unlike in the prior art, the sheet serving as the outer skin is not solid-colored itself, but a separate coloring layer is provided which is visible through the colorless transparent sheet to give the foamed vehicle part its color. Any tints or shadings, which could appear at the corners and edges in the prior art during reshaping of the solid-colored sheet, are prevented. It is further advantageous that, based on the method, the foamed vehicle part can have, e.g., a metallic-finish paint color that does not differ from the color of the rest of the vehicle body. In prior art solid-colored sheets, metallic particles that provide the metallic effect were able to align during reshaping of the sheet, as a result of which the metallic effect varied from that of the rest of the body.

The coloring layer is produced by painting. The same paint color may be used for both the foamed vehicle part and for the rest of the vehicle body. The color of the foamed vehicle part then corresponds exactly to the color of the painted vehicle body.

In one disclosed example, the coloring layer is flexible. The sheet and expanded layer have different coefficients of thermal expansion. The coloring layer compensates for the existing differences in thermal expansion of the sheet and the expanded layer. Accordingly, a tolerance compensation is ensured both during the process of providing the foamed backing and also in the assembled condition.

The invention further relates to a foamed vehicle part including an outer skin that is formed of a transparent, reshaped sheet. The outer skin has a front side and a rear side, the front side being visible from outside in the installed condition. The transparent, reshaped sheet is provided on a rear side with a coloring layer that is applied wet. The sheet with the coloring layer is provided with a foamed backing on a rear side to form an expanded layer. With regard to the advantages, reference is made to the above explanations.

These and other features of the present invention can be best understood from the following specification and drawings, the following of which is a brief description.

### BRIEF DESCRIPTION OF THE DRAWINGS

FIG. 1 shows a perspective view of a vehicle with a foamed vehicle part according to the invention in the form of a roof module; and

FIG. 2 shows a basic structure of a foamed vehicle part according to the invention.

### DETAILED DESCRIPTION OF THE PREFERRED EMBODIMENT

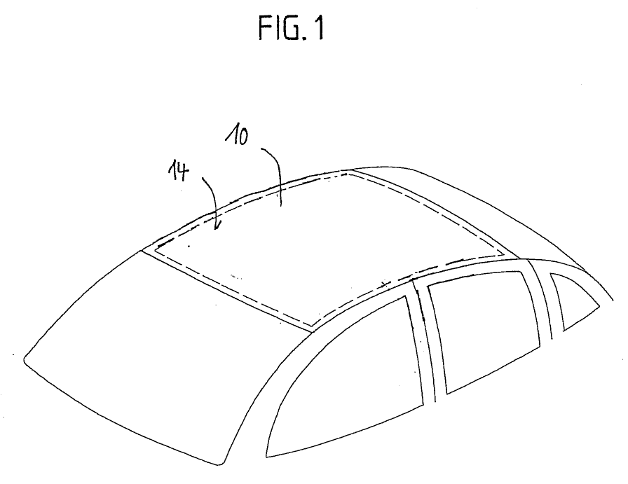

FIG. 1 shows a foamed vehicle part 10 in the form of a roof module in a condition mounted to a vehicle. The foamed vehicle part 10 could also be a fender, door, flap (engine hood, trunk lid), a spoiler, or a front part of a vehicle for example.

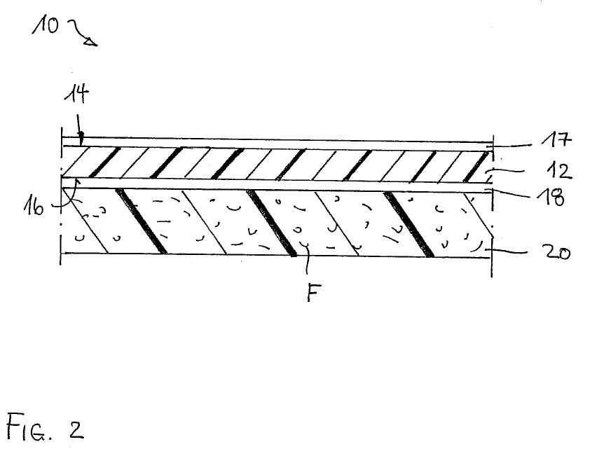

The basic structure of the foamed vehicle part 10 is shown in FIG. 2.

The foamed vehicle part 10 has an outer skin which is visible from outside in the condition mounted to the vehicle, and which is formed by a thin (0.5-1.5 mm) transparent reshaped sheet 12. The sheet 12 is made of a plastic material and has a front side 14, which is visible from outside in the installed condition, and a rear side 16.

The sheet 12 may be provided with a scratch-resistant coating 17 on the front side 14. The transparent scratch-resistant coating 17 is thin (0.2 mm) and protects the sheet 12.

The sheet 12 is provided with a foamed backing on the rear side. An expanded layer 20 produced in the process comprises a glass-fiber reinforced PU foam. The glass fibers F are introduced in foam by using the LFI method (long fiber injection) to reinforce the expanded layer 20.

Provided between the sheet 12 and the expanded layer 20 is a coloring layer 18 which is in the form of a coat of paint, for example. The coloring layer 18 is flexible, so that any tensions due to different coefficients of thermal expansion of the sheet 12 and the expanded layer 20 can be compensated for by the coloring layer 18. Moreover, the coloring layer 18 takes on a function of the exterior paintwork since the coloring layer 18 shines through, i.e. is visible through, the colorless and transparent sheet 12 and is visible from outside.

In the method of manufacturing the foamed vehicle part 10, the sheet 12 is provided with the scratch-resistant coating 17, if required, and is then reshaped by being deep-drawn or thermoplastically reshaped.

This is followed by a wet application of a paint on the rear side 16 of the sheet 12. The wet application can be carried out by knife coating, rolling, or by the spray-painting method. When the paint, which is applied wet, has dried, the coloring layer 18 has been formed, which is a coat of paint.

The sheet 12 is subsequently placed in a foaming mold (not shown) which includes an upper part and a lower part. With the foaming mold open, a liquid PU material is applied onto a rear side of the sheet 12 and the coloring layer 18, accompanied by the injection of glass fibers F (LFI method).

The two-part foaming mold is transferred to the closed condition and the PU material expands and fills a cavity formed between the lower and upper parts to constitute the expanded layer 20 after the foaming process. When the lower and upper parts have been separated and the foamed vehicle part 10 has been removed, the coloring layer 18 shines through the transparent colorless sheet 12, whereby any exterior paintwork of the foamed vehicle part 10 is eliminated. The same paint that is used for the adjoining vehicle body may also be used for the coloring layer 18, so that no differences in color will appear.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of manufacturing a foamed vehicle part, including the steps of:
(a) reshaping a transparent sheet serving as an outer skin, the transparent sheet having a front side and a rear side;
(b) applying a wet paint onto the rear side of the transparent sheet to form a coloring layer; and
(c) providing the transparent sheet with a foamed backing on the rear side.

2. The method according to claim 1, including drying the paint which forms the coloring layer prior to providing the foamed backing.

3. The method according to claim 1, wherein the coloring layer is produced by painting.

4. The method according to claim 1, wherein the coloring layer is produced by one of knife coating, rolling, and a spray-painting process.

5. The method according to claim 1, wherein the coloring layer is flexible.

6. The method according to claim 1, including deep-drawing the transparent sheet.

7. The method according to claim 1, including thermoplastically reshaping the transparent sheet.

8. The method according to claim 1, including applying a scratch-resistant coating to the transparent sheet.

9. The method according to claim 1, wherein step (a) is performed before step (b) and step (b) is performed before step (c).

10. A foamed vehicle part, comprising:
an outer skin that is formed of a transparent, reshaped sheet and has a front side and a rear side, the front side being visible from outside in an installed condition;
a coloring layer applied wet on the rear side of the transparent, reshaped sheet; and
a foamed backing provided on a rear side of the transparent, reshaped sheet and coloring layer to form an expanded layer.

11. The vehicle part according to claim 10, wherein the coloring layer is a coat of paint.

12. The vehicle part according to claim 10, wherein the coloring layer is flexible.

13. The vehicle part according to claim 10, wherein the transparent, reshaped sheet is deep-drawn.

14. The vehicle part according to claim 10, wherein the transparent, reshaped sheet is thermoplastically reshaped.

15. The vehicle part according to claim 10, wherein the transparent, reshaped sheet is provided with a scratch-resistant coating.
